(19) United States
(12) Patent Application Publication
(10) Pub. No.: US 2008/0198229 A1
(43) Pub. Date: Aug. 21, 2008

(54) VEHICLE OPERATION SUPPORT SYSTEM AND VEHICLE INCLUDING SYSTEM

(75) Inventor: Hitoshi HONGO, Shijonawate City (JP)

Correspondence Address: NDQ&M WATCHSTONE LLP, 1300 EYE STREET, NW, SUITE 1000 WEST TOWER, WASHINGTON, DC, 20005, US

(73) Assignee: SANYO ELECTRIC CO., LTD., Moriguchi City (JP)

(21) Appl. No.: 12/034,170

(22) Filed: Feb. 20, 2008

(30) Foreign Application Priority Data
Feb. 21, 2007 (JP) JP2007-040933

(51) Int. Cl. H04N 7/18

(52) U.S. Cl. 348/148; 348/E07.085

(57) ABSTRACT

A vehicle operation support system is provided in which a captured image or a guide displayed on a display device can be adjusted easily by a simple operation. In adjusting misalignment between the image and the guide displayed as an oblique captured image on the display device, the user converts the displayed image and guide to a so-called high-angle display (which is displayed as if looked down directly from the above), and the converted high-angle image is then corrected or adjusted so that the image and the guide are displayed in correct alignment as desired.

### CROSS REFERENCE TO RELATED APPLICATIONS

This application claims priority based on 35 USC 119 from prior Japanese Patent Application No. P2007-040933 filed on Feb. 21, 2007, the entire contents of which are incorporated herein by reference.

### BACKGROUND OF THE INVENTION

1. Field of the Invention

This invention relates generally to a vehicle operation support system used when operating a vehicle and a vehicle having such a vehicle operation support system, and more particularly to a vehicle operation support system that displays a guide to assist the vehicle operator, such as when operating the vehicle in reverse gear and a vehicle having such a vehicle operation support system.

2. Description of Related Art

A vehicle operation support system is known in which a camera is installed at the back of a vehicle to capture images of the region behind the vehicle and a display device is provided for the driver inside the vehicle to display the captured images from the camera along with a guide for assisting the driver in maneuvering the vehicle in reverse gear. A guide here means a line that indicates the vehicle's width, a graphic form or a field that occupies a certain area, or a line that indicates a certain distance from the leading end or the back-end of the vehicle.

With such a vehicle operation support system, the driver can see potential obstacles in the area behind the vehicle by viewing the display device, thus making it possible for the driver to maneuver the vehicle in reverse safely. The use of the guide also makes it possible for the driver to operate in reverse gear easily. Japanese Laid-Open No. 2000-272445 discloses a technology to display a guide to support such reverse gear operation.

In the above vehicle operation support system, however, a captured image, or the position or angle of the guide may be shifted out of alignment and may not be shown properly on the display device when the initial positioning of the camera as installed during manufacture is shifted out of alignment by some external occurrence, for example. Also, when the camera is mounted on a vehicle as a retrofit, there may be an instance where a captured image, or the position or angle of the guide is out of alignment and may not be shown properly on the display device, such as by improper installation positions of the camera by aftermarket personnel.

In such instances, it is necessary for the captured image or the position or angle of the guide to be adjusted so that it is displayed correctly. Adjustment of the captured image or the position or angle of the guide can be achieved by adding a function allowing an operator to change the captured image or the position or angle of the guide.

However, the image displayed on the display device is captured by the image pickup device from its installed position on the vehicle in a direction that is obliquely downward. Therefore, a rectangular marker plate placed on the ground for alignment of the guide for example will not be shown in the captured image as rectangular but as a trapezoid because of the oblique perspective of the camera. It is a very difficult and complex operation to adjust the captured image or the position or angle of the guide accurately by the user based on such a captured image.

FIG. 1 shows a structure of a conventional vehicle operation support system. An image pickup device 103 is installed at the back of a vehicle 101. In FIG. 1, the image pickup device 103 is installed in such a way that a bumper 102 of the vehicle 101 is captured in the image taken from the installed position in the obliquely downward direction. A display device 104 is provided in the vehicle 101 for monitoring the captured image of the image pickup device 103.

FIG. 2 shows one example of a marker plate for use in adjusting a guide. The marker plate of FIG. 2 has grid-like lines thereon that are used for adjusting the guide alignment. The marker plate is prepared so that its lateral length for example corresponds to the vehicle width.

FIG. 3 shows a captured image 200 of the bumper 102 (which will be referred to as a bumper image 200 below) and a captured image 201 of the marker plate (which will be referred to as a marker plate image 201 below) that are displayed on the display device 104 when the marker plate of FIG. 2 is positioned on the ground at a predetermined position behind the vehicle and the image is captured by the image pickup device 103. Guide line lines 202 and 203 also are shown in superposition with these images.

In FIG. 3, relative positioning between the marker plate image 201 and the bumper image 200, and the guide lines 202 and 203 is shifted out of alignment due to the misaligned installation of the image pickup device 103. On the other hand, FIG. 4 shows an example in which relative positioning of the marker plate image 201 and the bumper image 202, and the guide lines 202 and 203 is properly displayed. It is a difficult and complex operation for the user to adjust the captured image or the position or angle of the guide from the state shown in FIG. 3 to the state shown in FIG. 4.

### SUMMARY OF THE INVENTION

This invention was made in view of the above problems, and one object of this invention, therefore, is to provide a vehicle operation support system that can adjust the alignment between a captured image and a guide displayed on a display device easily by a simple operation, and to provide a vehicle having such a vehicle operation support system.

In order to achieve the above objects, one aspect of the invention provides a vehicle operation support system having an image switching unit for generating and outputting a high-angle image based on an oblique image captured by the image pickup device installed on the vehicle; a guide control unit for outputting a guide for the high-angle image to support vehicle operations; a display control unit for generating a superimposed high-angle image in which the high-angle image and the guide for the high-angle image are superimposed and outputting the superimposed high-angle image to a display device; an operation input unit; and an image control unit. In accordance with an entered first operation from the operation input unit, the image control unit or the guide control unit changes a first positional relation between the high-angle image and the guide for the high-angle image on the display device.

Preferably, the image switching unit outputs an original oblique captured image corresponding to the high-angle image, and the guide control unit outputs a guide for the oblique captured image to support vehicle operations, and the display control unit generates a superimposed oblique captured image in which the oblique captured image and the guide for the oblique captured image are superimposed and outputs the superimposed oblique captured image to the display device. Based on the amount of change in the above first positional relation, the image control unit or the guide control unit changes a second positional relation between the oblique captured image and the guide for the oblique captured image on the display device.

Preferably, the image switching unit generates a high-angle image in which a mounting angle of the image pickup device is changed according to a second operation from the operation input unit.

Another aspect of the invention provides a vehicle having an image pickup device; a display device; an image switching unit for generating and outputting a high-angle image based on an oblique captured image by the image pickup device; a guide control unit for outputting a guide for the high-angle image to support vehicle operations; a display control unit for generating a superimposed high-angle image in which the high-angle image and the guide for the high-angle image are superimposed and outputting the superimposed high-angle image to the display device; an operation input unit; and an image control unit. According to an entered operation from the operation input unit, the image control unit or the guide control unit changes a first positional relation between the high-angle image and the guide for the high-angle image on the display device.

Preferably, the image switching unit outputs an original oblique captured image corresponding to the high-angle image, and the guide control unit outputs a guide for the oblique captured image to support vehicle operations, and the display control unit generates a superimposed oblique captured image in which the oblique captured image and the guide for the oblique captured image are superimposed and outputs the superimposed oblique captured image to the display device. The image control unit or the guide control unit changes a second positional relation between the oblique captured image and the guide for the oblique captured image on the display device based on the amount of change in the above first positional relation.

The image switching unit preferably generates a high-angle image in which a mounting angle of the image pickup device is changed according to a second operation from the operation input unit.

### BRIEF DESCRIPTION OF THE DRAWINGS

FIG. 1 is a schematic view of a conventional vehicle operation support system installed on a vehicle;

FIG. 2 is a schematic view showing a marker plate used for adjusting a guide;

FIG. 3 is a figure in which an oblique captured image and guides are shown on the display as being out of alignment with each other;

FIG. 4 is a figure in which the oblique captured image and the guides are shown in correct alignment on the display;

FIG. 5 is a block diagram showing a whole configuration of the vehicle operation support system according to one embodiment of the invention;

FIG. 6 is a schematic view of the vehicle operation support system according to the embodiment being installed on a vehicle;

FIG. 7 is a schematic view for explaining the difference between an oblique captured image and a high-angle image;

FIG. 8 is an explanatory view showing a method to generate the high-angle image from the oblique captured image;

FIGS. 9A to 9C show a high-angle image generated with different depression angles;

FIG. 10 is a view for explaining displacement and rotation of an image displayed on the display device;

FIG. 11 is a view for explaining displacement and rotation of a guide displayed on the display device;

FIG. 12 is a schematic view showing an arrangement of the vehicle for adjusting an image and guides displayed on the display device;

FIG. 13 is a figure in which an oblique captured image and guides for the oblique captured image are displayed during the guide adjustment;

FIG. 14 is a figure in which a high-angle image and guides for the high-angle image are displayed during the guide adjustment;

FIG. 15 is a figure in which the high-angle image and the guides for the high-angle image are displayed during the guide adjustment;

FIG. 16 is a figure in which the high-angle image and the guides for the high-angle image are displayed during the guide adjustment;

FIG. 17 is a figure in which the high-angle image and the guides for the high-angle image are displayed during the guide adjustment; and

FIG. 18 is a figure in which the oblique captured image and the guides for the oblique captured image are displayed during the guide adjustment.

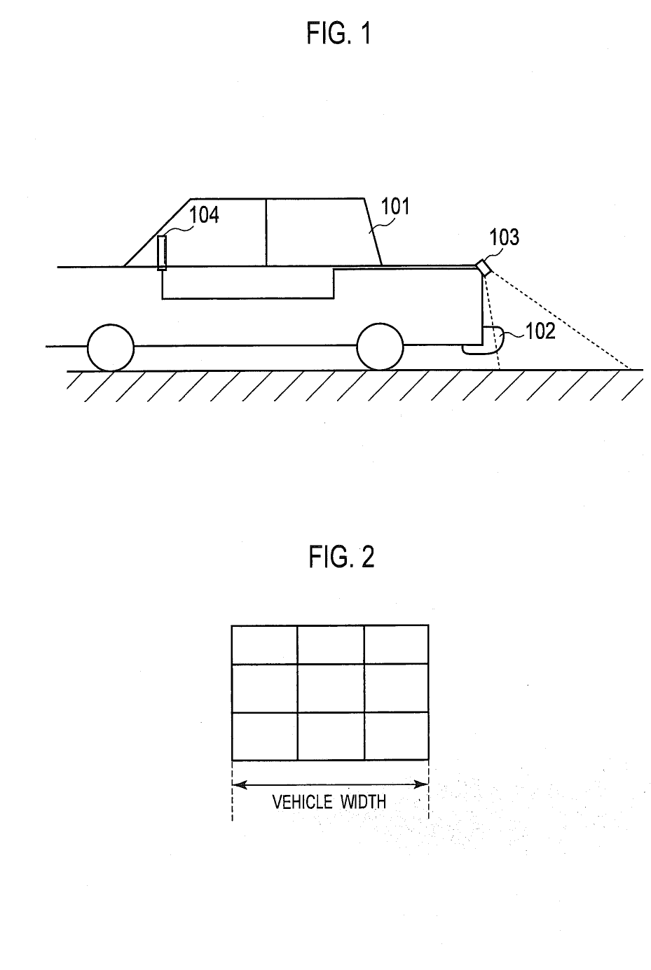

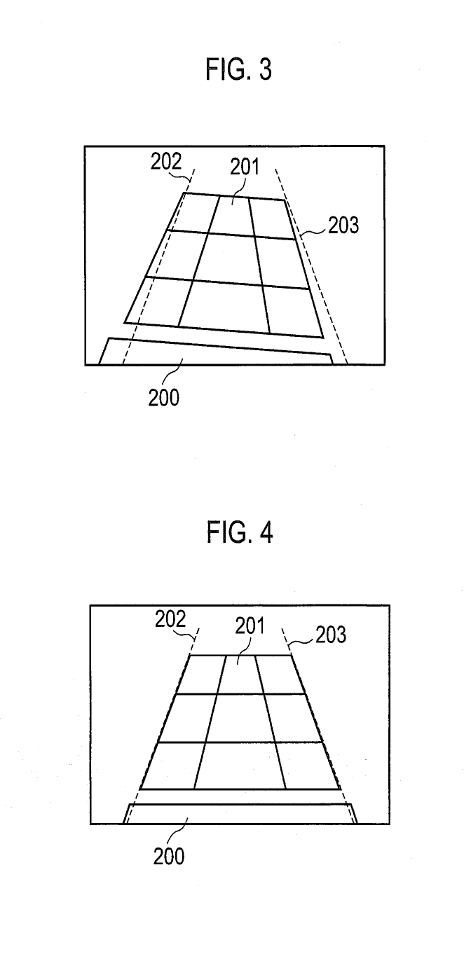

### DETAILED DESCRIPTION OF EMBODIMENTS

Preferred embodiments of the invention will be described below with reference to the accompanying drawings. The same reference numbers are assigned to the same parts in each of the drawings being referred to, and overlapping explanations for the same parts are omitted in principle.

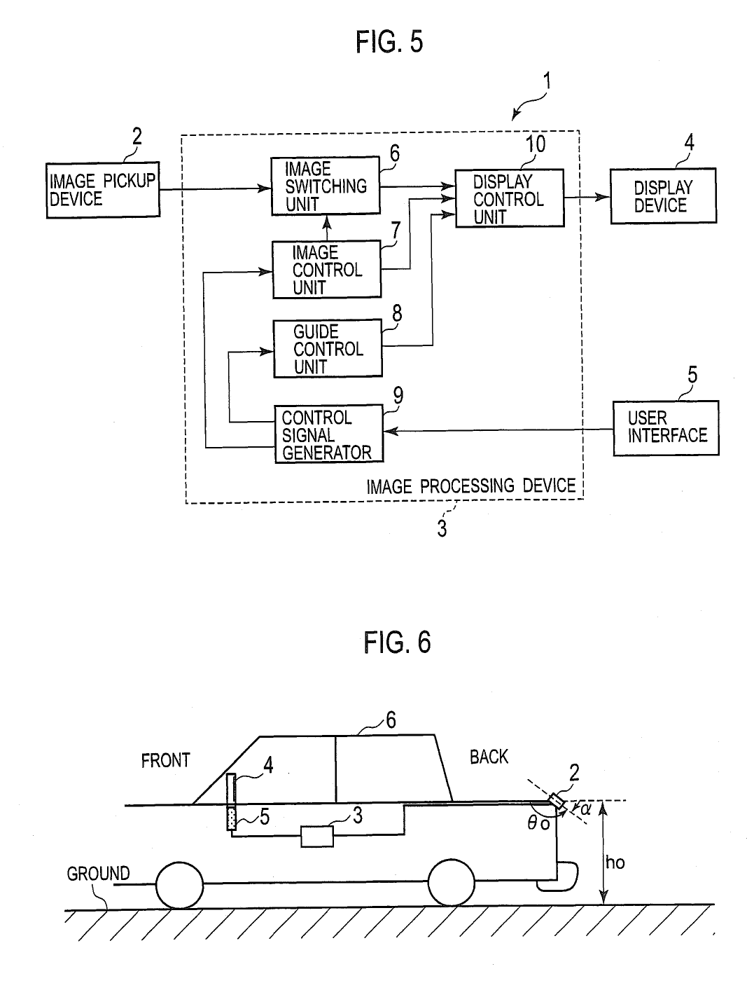

FIG. 5 is a block diagram showing a detailed configuration (i.e. functional configuration) of the vehicle operation support system according to one embodiment of the invention. A vehicle operation support system 1 has an image pickup device 2 for capturing an image behind the vehicle and an image processing device 3 for performing image processing and image control on the captured image and display control of the guide. A CCD camera, for example, may be used for the image pickup device 2.

The vehicle operation support system 1 further includes a display device 4 for displaying an image and a superimposed guide outputted from the image processing device 3. The vehicle operation support system 1 also includes a user interface 5 for receiving operations from a user, generating electric signals corresponding to the operation (which will be referred to as operation signals below), and outputting them to the image processing device 3. A liquid crystal monitor, for example, may be used for the display device 4. The user interface 5 has input means such as an adjustment button or an adjustment knob, so that a desired operation can be entered by the user using such input means.

The image processing device 3 includes an image switching unit 6, an image control unit 7, a guide control unit 8, a control signal generator 9, and a display control unit 10. The image switching unit 6 generates a high-angle image from an oblique captured image by the image pickup device 2 in accordance with signals outputted from the image control unit 7. The image switching unit 6 also outputs the generated high-angle image or the original captured image to the image control unit 10.

FIG. 6 shows the vehicle operation support system 1 in the case of being applied on a vehicle. As shown in FIG. 6, the image pickup device 2 is installed at the rear part of the vehicle 6 at a position having a height of hₒ from the ground. With the clockwise rotation considered as a positive direction, the slope of the image pickup device 2 relative to the horizontal direction will be called a depression angle a, and an angle θₒ (θₒ=180−a) will be called a mounting angle.

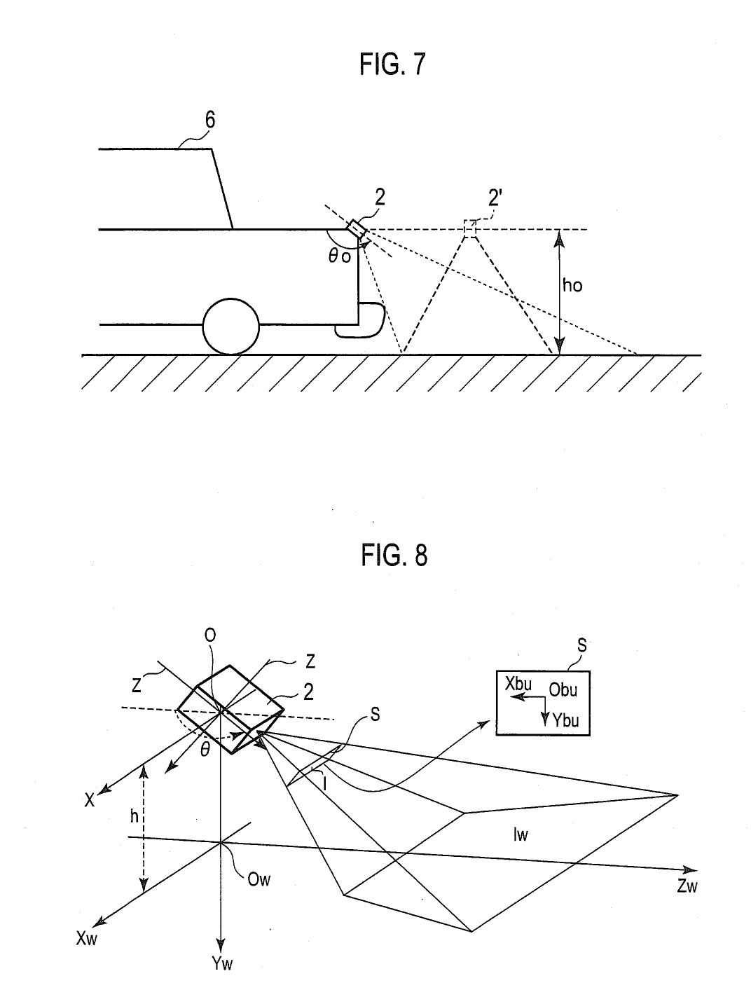

FIG. 7 is a schematic view for explaining a relation between the oblique captured image and the high-angle image. In FIG. 7, the image pickup device 2 installed on the vehicle 6 captures an image in the oblique-downward direction at the height hₒ from the ground. Such an image captured in the oblique-downward direction will be called an oblique captured image. On the other hand, an image captured by a virtual image pickup device 2′ positioned directly above the image-capturing subject will be called a high-angle image. Therefore, the image captured by the image pickup device 2 may be referred to as the oblique captured image below.

FIG. 8 is an explanatory view showing a technique to convert an oblique captured image to a high-angle image (observing point transformation). FIG. 8 shows the relationships among a coordinate system XYZ of the image pickup device 2, a coordinate system X_{bu}Y_{bu} of an imaging area S of the image pickup device 2, and a world coordinate system X_{w}Y_{w}Z_{w} that includes a two-dimensional ground coordinate system X_{w}Z_{w}.

The coordinate system XYZ of the image pickup device 2 has its origin O at the optical center of the image pickup device 2, its Z axis in the optical axis direction, its X axis in the direction perpendicular to the Z axis and parallel to the ground, and its Y axis in the direction perpendicular to the Z and X axes.

The coordinate system X_{bu}Y_{bu} of the imaging area S has its origin O_{bu} at the center of the imaging area S, its X_{bu} axis in the horizontal direction of the imaging area S, and its Y_{bu} axis in the vertical direction.

The world coordinate system X_{w}Y_{w}Z_{w} has its origin O_{w} at the intersecting point of the perpendicular line that runs through the origin O of the coordinate system XYZ of the image pickup device and the ground, its Y_{w} axis in the direction perpendicular to the ground, its X_{w} axis in the direction parallel to the X axis of the coordinate system XYZ of the image pickup device, and its Z_{w} axis in the direction perpendicular to the X_{w} and Y_{w} axes.

In FIG. 8, the image pickup device 2 is positioned at the height h from the ground, and therefore, the amount of parallel displacement between the world coordinate system X_{w}Y_{w}Z_{w} and the coordinate system XYZ of the image pickup device is [0, h, 0]. The amount of rotation around the X axis is θ.

Accordingly, a conversion formula between coordinates (x, y, z) of the coordinate system XYZ of the image pickup device and coordinates (x_{w}, y_{w}, z_{w}) of the world coordinate system X_{w}Y_{w}Z_{w} is expressed by the following formula (1).

$$[ \begin{matrix}x \\ y \\ z\end{matrix} ] = [ \begin{matrix}1 & 0 & 0 \\ 0 & cos θ & - sin θ \\ 0 & sin θ & cos θ\end{matrix} ] \{ [ \begin{matrix}{x}_{w} \\ {y}_{w} \\ {z}_{w}\end{matrix} ] + [ \begin{matrix}o \\ h \\ o\end{matrix} ] \} \qquad ( 1 )$$

Also, when the focal length of the image pickup device 2 is f, a conversion formula between coordinates (x_{bu}, y_{bu}) of the coordinate system X_{bu}Y_{bu} of the imaging area S and coordinates (x, y, z) of the coordinate system XYZ of the image pickup device 2 is expressed by the following formula (2).

$$[ \begin{matrix}{x}_{bu} \\ {y}_{bu}\end{matrix} ] = [ \begin{matrix}f \frac{x}{z} \\ f \frac{y}{z}\end{matrix} ] \qquad ( 2 )$$

From the above formulae, the oblique captured image can be converted to the high-angle image. In other words, the area I_{w} of the X_{w}Z_{w} plane in the world coordinate system X_{w}Y_{w}Z_{w} is the area captured by the image pickup device 2, whereas the image converted from the captured image (oblique captured image) to the area I of the coordinate system X_{bu}Y_{bu} of the imaging area S by the observing point transformation is the high-angle image. Such observing point transformation processing is described in JP Laid-Open No. 2006-287892.

In the above formula (1), by setting the parameter h indicating the height of the image pickup device 2 from the ground to be the actual installation position hₒ of the image pickup device 2 (h=hₒ), a high-angle image from the virtual image pickup device 2′ can be generated.

Also, the parameter θ indicating the rotation of the image pickup device 2 relative to the horizontal direction needs to be set to the actual mounting angle of the image pickup device 2. If a value different from the actual mounting angle is set, the generated high-angle image may have distortion and appear distorted to the viewer. In this embodiment, the mounting angle of the image pickup device 2 is θₒ, and therefore, a correct high-angle image can be generated by setting θ=θₒ.

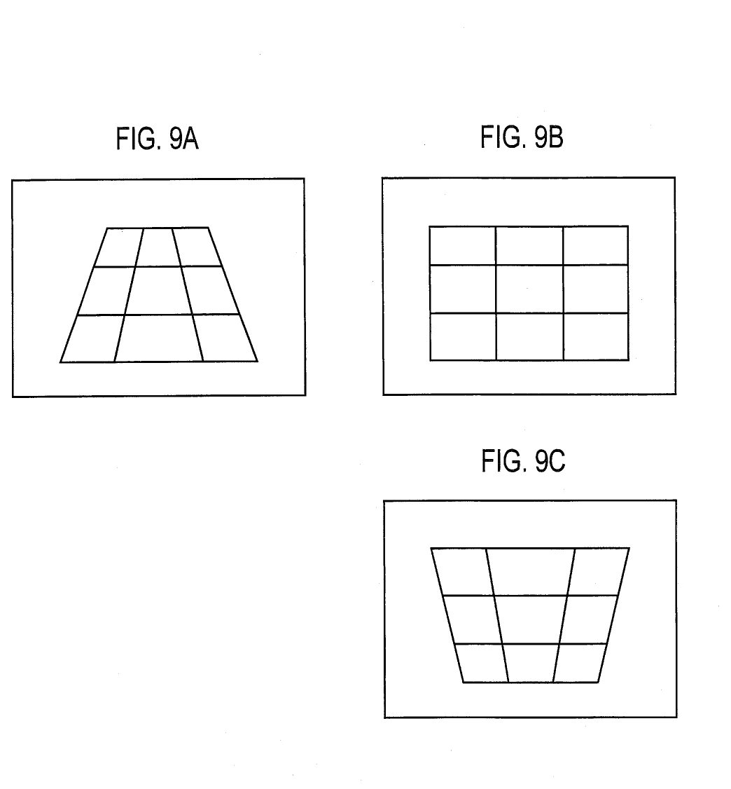

FIG. 9A shows an oblique captured image of the marker plate. FIGS. 9B and 9C show figures converted from the oblique captured image of FIG. 9A to a high-angle image. FIG. 9C is a high-angle image in which the actual mounting angle θₒ of the image pickup device 2 and the value of θ set in the above formula (1) are different. In FIG. 9C, the generated high-angle image is distorted and the rectangle marker plate is shown in a trapezoidal shape.

In accordance with output signals from the control signal generator 9, the image control unit 7 instructs the image switching unit 6 to generate a high-angle image or to output an original oblique captured image, or instructs the display control unit 10 to rotate, or move from side to side or up and down the image outputted from the image switching unit 6.

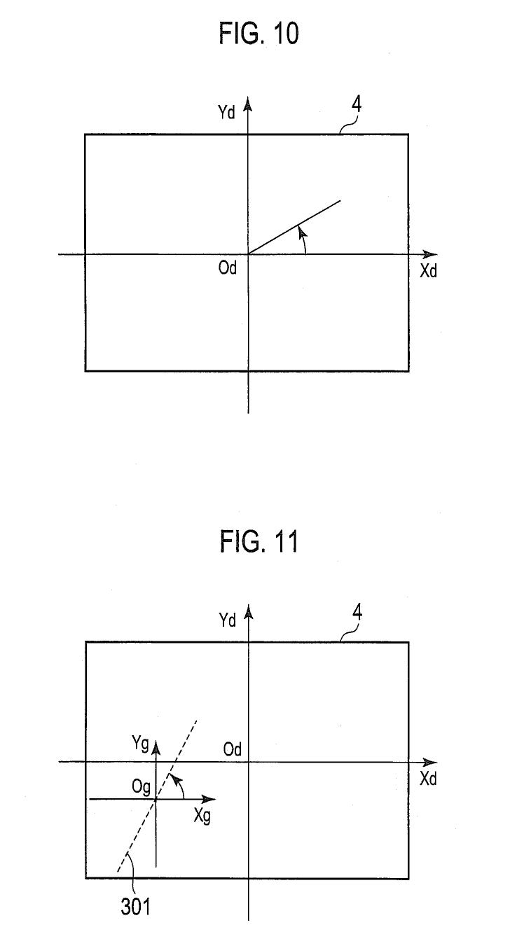

FIG. 10 shows a display screen of the display device 4. In FIG. 10, a coordinate system X_{d}-Y_{d} has its origin O_{d} at the center of the display screen, and has its X_{d} axis in the horizontal direction of the display screen and its Y_{d} axis in the vertical direction of the display screen. “Rotating the image” means rotating the image displayed on the display screen (other than the guide) a predetermined angle around the origin O_{d} from the X_{d} axis. “Moving the image” means moving the image displayed on the display screen (other than the guide) a predetermined amount parallel to the X_{d} axis or the Y_{d} axis.

The guide control unit 8 outputs to the image control unit 10 a guide for the high-angle image or a guide for the oblique captured image in accordance with output signals from the control signal generator 9. Here, the configuration of the guide for the high-angle image and that of the guide for the oblique captured image are the same except that the guide for the high-angle image is shown as it would appear looking directly down from above, while the guide for the oblique captured image is shown as it would appear looking down in the oblique direction from above. The guide control unit 8 instructs the display control unit 10 to rotate the guide, or move the guide from side to side or up and down in accordance with output signals from the control signal generator 9.

FIG. 11 shows a figure in which just one guide line 301 is shown on a display screen of the display device 4. In FIG. 11, a coordinate system X_{g}-Y_{g} is configured to have its origin O_{g}at the midpoint of the guide line 301, and its X_{g} axis in the horizontal direction of the display screen and its Y_{g} axis in the vertical direction of the display screen, in addition to the coordinate system X_{d}-Y_{d} having its origin O_{d} at the center of the display screen, and its X_{d} axis in the horizontal direction of the display screen and its Y_{d} axis in the vertical direction of the display screen. “Rotating the guide” means rotating the guide line 301 displayed on the display screen a predetermined angle around the origin O_{g} from the X_{g} axis. “Moving the guide” in the direction from side to side or up and down means moving the guide line 301 a predetermined amount parallel to the X_{d} axis or the Y_{d} axis in the coordinate system X_{d}-Y_{d}.

The display control unit 10 outputs the image outputted from the image switching unit 6 and the guide outputted from the guide control unit 8 in superposition. The guide displayed on the display device 4 is moved or rotated in accordance with instructions to move or rotate the guide from the guide control unit 8. Similarly, in accordance with the instructions to move or rotate the image from the image control unit 7, the image displayed on the display device 4 is moved or rotated. The image (either the oblique captured image or the high-angle image) and the guide (either the guide for the oblique captured image or the guide for the high-angle image) are thus displayed in superposition.

The control signal generator 9 generates control signals corresponding to operation signals from the user interface 5 and outputs to the guide control unit 8 and the image control unit 7.

Next, functions of the vehicle operation support system 1 will be described in more detail below. The user interface 5 can receive instructions for the following operations (1) to (7) from a user to be performed with respect to the image (either the oblique captured image or the high-angle image) or the guide (either the guide for the oblique captured image or the guide for the high-angle image) displayed on the display device 4.

(1) displacing operation of the displayed image in the horizontal or vertical direction;

(2) rotating operation of the displayed image;

(3) changing operation of the parameter E or the parameter h of the high-angle image;

(4) switching operation from the high-angle image to the oblique captured image;

(5) switching operation from the oblique captured image to the high-angle image;

(6) displacing operation of the displayed guide in the horizontal or vertical direction; and

(7) rotating operation of the guide.

The user interface 5 generates and outputs operation signals corresponding to these operations to the control signal generator 9.

When the control signal generator 9 receives operation signals of the above operations (1) to (5), it generates control signals corresponding to these operations and outputs them to the image control unit 7. Also, when the control signal generator 9 accepts operation signals of the above operations (4) to (7), it generates control signals corresponding to these operations and outputs them to the guide control unit 8.

When the image control unit 7 receives control signals for the above operation (1), it derives displacement values for the image displayed on the display device 4 in the horizontal and vertical directions, and outputs them to the display control unit 10 along with instructions to move the image. At this time, if the image displayed on the display device 4 is the high-angle image, the derived displacement values are stored in a mounted memory unit for the image adjustment amounts (not shown) as the image displacement values for the high-angle image, and in addition, displacement values in the case of displaying the oblique captured image corresponding to this high-angle image also are derived from this image displacement values and stored in the memory unit for the image adjustment amounts as the image displacement values for the oblique captured image.

On the other hand, if the displayed image is the oblique captured image, the image displacement values for the oblique captured image are stored in the memory unit for the image adjustment amounts as the image displacement values for the oblique captured image, and in addition, displacement values in the case of displaying the high-angle image corresponding to this oblique captured image also are derived and stored in the memory unit for the image adjustment amounts as the image displacement values for the high-angle image.

When the image control unit 7 receives control signals for the above operation (2), it derives a rotation amount for the image displayed on the display device 4 and outputs it to the display control unit 10 along with instructions to rotate the image. At this time, if the image displayed on the display device 4 is the high-angle image, the derived rotation amount is stored in the memory unit for the image adjustment amounts as the image rotation amount for the high-angle image, and in addition, a rotation amount in the case of displaying the oblique captured image corresponding to this high-angle image also is derived from this image rotation amount and stored in the memory unit for the image adjustment amounts as the image rotation amount for the oblique captured image.

On the other hand, if the image displayed is the oblique captured image, the image rotation amount for the oblique captured image is stored in the memory unit for the image adjustment amounts as the image rotation amount for the oblique captured image, and in addition, a rotation amount in the case of displaying the high-angle image corresponding to this oblique captured image also is derived and stored in the memory unit for the image adjustment amounts as the image rotation amount for the high-angle image.

When the image control unit 7 receives control signals for the above operation (3), it derives the values of the parameters θ and h based on the control signals and stores them in the memory unit for the image adjustment amounts. Then, the image control unit 7 instructs the image switching unit 6 to generate the high-angle image corresponding to the derived values θ and h, and instructs the display control unit 10 to move and rotate the high-angle image based on the image displacement and rotation amounts stored in the memory unit for the image adjustment amounts. The user interface 5 accepts the above operation (3) only when a high-angle image is displayed on the display device 4.

When the image control unit 7 receives control signals for the above operation (4), it instructs the image switching unit 6 to output the oblique captured image. At this time, if the image displacement and rotation amounts for the oblique captured image are stored in the memory unit for the image adjustment amounts, the image control unit 7 instructs displacement and rotation of the oblique captured image to the display control unit 10 based on the displacement and rotation amounts. The user interface 5 accepts the above operation (4) only when a high-angle image is displayed on the display device 4.

When the image control unit 7 receives control signals for the above operation (5), it instructs the image switching unit 6 to output the high-angle image. At this time, if the image displacement and rotation amounts for the high-angle image are stored in the memory unit for the image adjustment amounts, the image control unit 7 instructs displacement and rotation of the high-angle image to the display control unit 10 based on the displacement and rotation amounts. The user interface 5 accepts the above operation (5) only when an oblique captured image is displayed on the display device 4.

When the guide control unit 8 receives control signals for the above operation (4), it outputs the guide for the oblique captured image. At this time, if the guide displacement and rotation amounts for the guide for the oblique captured image are stored in a mounted memory unit for the guide adjustment amounts, the guide control unit 8 instructs displacement and rotation of the guide for the oblique captured image to the display control unit 10 based on the displacement and rotation amounts. As described above, the user interface 5 accepts the above operation (4) only when a high-angle image is displayed on the display device 4.

When the guide control unit 8 receives control signals for the above operation (5), it outputs the guide for the high-angle image. At this time, if the guide displacement and rotation amounts for the guide for the high-angle image are stored in the memory unit for the guide adjustment amounts, the guide control unit 8 instructs displacement and rotation of the guide for the high-angle image to the display control unit 10 based on the displacement and rotation amounts. As described above, the user interface 5 accepts the above operation (5) only when an oblique captured image is displayed on the display device 4.

When the guide control unit 8 receives control signals for the above operation (6), it derives a displacement value of the guide displayed on the display device 4 in the horizontal direction and a displacement value of the guide in the vertical direction, and outputs them to the display control unit 10 along with instructions to move the guide. At this time, if the image displayed on the display device 4 is the high-angle image, the derived displacement values are stored in the memory unit for the guide adjustment amounts as the guide displacement values for the high-angle image, and in addition, displacement values in the case of displaying the oblique captured image corresponding to this high-angle image also are derived from this guide displacement values and stored in the memory unit for the guide adjustment amounts as the guide displacement values for the oblique captured image.

On the other hand, if the image displayed is the oblique captured image, the guide displacement values for the oblique captured image are stored in the memory unit for the guide adjustment amounts, and in addition, displacement values in the case of displaying the high-angle image corresponding to this oblique captured image also are derived and stored in the memory unit for the guide adjustment amounts as the guide displacement values for the high-angle image.

When the guide control unit 8 receives control signals for the above operation (7), it derives a rotation amount of the guide displayed on the display device 4 and outputs it to the display control unit 10 along with instructions to rotate the guide. At this time, if the image displayed on the display device 4 is the high-angle image, the derived rotation amount is stored in the memory unit for the guide adjustment amounts as the guide rotation amount for the high-angle image, and in addition, a rotation amount in the case of displaying the oblique captured image corresponding to this high-angle image also is derived from this guide rotation amount and stored in the memory unit for the guide adjustment amounts as the guide rotation amount for the oblique captured image.

On the other hand, if the image displayed is the oblique captured image, the guide rotation amount for the oblique captured image is stored in the memory unit for the guide adjustment amounts, and in addition, a rotation amount in the case of displaying the high-angle image corresponding to this oblique captured image also is derived and stored in the memory unit for the guide adjustment amounts as the guide rotation amount for the high-angle image.

Although the memory unit for the image adjustment amounts and the memory unit for the guide adjustment amounts are described as being separate memory units in the above explanation, they also can be one common memory unit.

Next, a method to adjust the image and the guide displayed on the display device 4 using the vehicle operation support system 1 will be explained below. In the following explanation, the displayed image (i.e., the oblique captured image or the high-angle image) and the displayed guide (i.e., the guide for the oblique captured image or the guide for the high-angle image) are collectively referred to as the guide. The vehicle operation support system 1 has a mode for adjusting the guide which allows a user to adjust the guide in that mode.

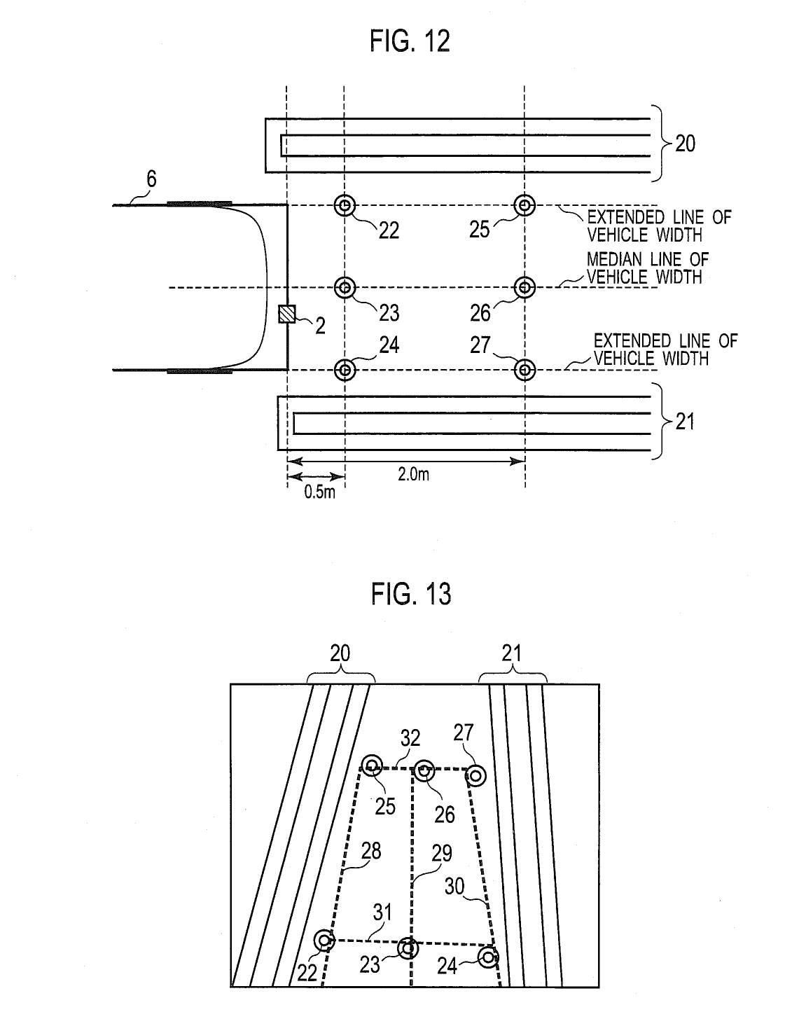

FIG. 12 shows arrangements of the vehicle 6 and adjustment aids 22 to 27 used when performing adjustments of the guide. In FIG. 12, it is shown that the vehicle 6 is positioned at a place where parallel lines 20 and 21 are drawn on the ground such as at a parking lot. In FIG. 12, the image pickup device 2 is mounted at a position slightly out of alignment towards the left side from the median line of the vehicle 6. Here, the determination of left or right relative to the vehicle 6 is made relative to the forward direction of the vehicle 6.

The vehicle 6 is arranged such that lines of its right edge and its left edge are parallel to the parallel lines 20 and 21. The adjustment aids 22 and 25 are arranged on the extended line of the right edge of the vehicle 6, and the adjustment aids 24 and 27 are arranged on the extended line of the left edge of the vehicle 6. The adjustment aids 23 and 26 are arranged on the median line of the vehicle 6.

Also, the adjustment aids 22 to 24 are arranged at the positions 0.5 m from the rear edge of the vehicle 6, and the adjustment aids 25 to 27 are arranged at the positions 2.0 m from the rear edge of the vehicle 6. In the arrangements of FIG. 12, the image pickup device 2 can capture images of the parallel lines 20 and 21 as well as the adjustment aids 22 to 27.

FIG. 13 is a figure in which a captured image of the parallel lines 20 and 22, and of the adjustment aids 22 to 27 (an oblique captured image) and guides for the oblique captured image 28-32 are displayed on the display device 4 in superposition. In FIG. 13, the guides for the oblique captured image 28-32 are displayed by the guide control unit 8.

The guide 28 indicates the extended line of the right edge of the vehicle 6, and the guide 30 is a guide to indicate the extended line of the left edge of the vehicle 6. The guide 29 indicates the median line of the vehicle 6. The guides 31 and 32 respectively indicate the positions of 0.5 m and 2.0 m from the rear edge of the vehicle 6.

Therefore, each guide needs to be displayed on the display device 4 such that it satisfies at least the conditions below.

(1) the guide 28 passes through the adjustment aids 22 and 25;

(2) the guide 29 passes through the adjustment aids 23 and 26;

(3) the guide 30 passes through the adjustment aids 24 and 27;

(4) the guide 31 passes through the adjustment aids 22, 23 and 24; and

(5) the guide 32 passes through the adjustment guides 25, 26 and 27.

As shown in FIG. 13, however, each guide does not satisfy the above conditions (1) to (5). In other words, the guide is not displayed correctly. By performing the following operations at the vehicle operation support system 1, therefore, the guide can be adjusted such that the above conditions (1) to (5) can be satisfied.

(1) Switching Operation from the Oblique Captured Image to the High-Angle Image

When the switching operation from the oblique captured image to the high-angle image is performed, the image control unit 7 instructs the image switching unit 6 to generate the high-angle image. Also, the guide control unit 8 outputs the guide for the high-angle image to the image control unit 10.

In the case that the parameter θ used at the time of generating the high-angle image is not appropriate, the high-angle image displayed on the display device 4 will be distorted. In such a case, the distortion can be resolved by changing the value θ to an appropriate value by the “changing operation of the parameter θ of the high-angle image.”

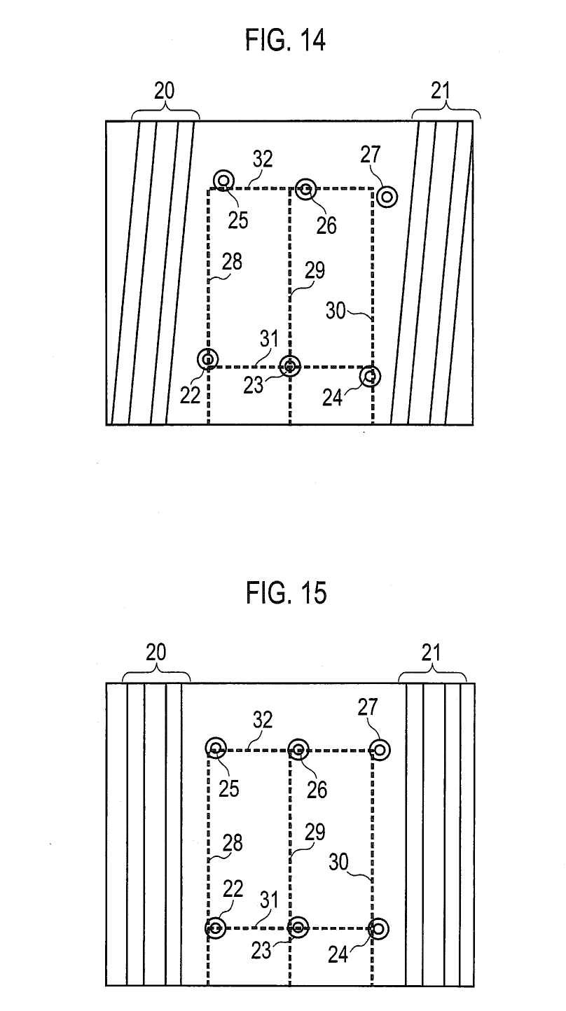

FIG. 14 shows the oblique captured image of FIG. 13 converted to the high-angle image, and the guides for the high-angle image are displayed over the high-angle image in superposition. From FIG. 14, it can be seen that the high-angle image is displayed in such a way that it is somewhat tilted relative to the guides 28, 29, and 30.

(2) Rotating Operation of the Image (High-Angle Image)

When a rotating operation of a predetermined rotation amount is performed for the displayed high-angle image, the image control unit 7 instructs the display control unit 10 to rotate the high-angle image as much as the predetermined rotation amount. At this time, the image control unit 7 stores the rotation amount in the memory unit for the image adjustment amounts as the image rotation amount for the high-angle image, and in addition, it derives a rotation amount in the case of displaying the oblique captured image corresponding to this high-angle image and stores it in the memory unit for the image adjustment amounts as the image rotation amount for the oblique captured image.

FIG. 15 is a figure in which the high-angle image was rotated as much as the predetermined value. It can be seen that the inclination of the high-angle image is corrected in FIG. 15. However, it can be seen that each guide still is somewhat out of alignment in the horizontal direction because the guides 28, 29, and 30 do not pass through the corresponding adjustment aids.

(3) Displacing Operation of the Image (High-Angle Image) in the Horizontal Direction

When a displacing operation of a predetermined displacement value is performed for the displayed high-angle image, the image control unit 7 instructs the display control unit 10 to move the high-angle image as much as the predetermined displacement value. At this time, the image control unit 7 stores the displacement value in the memory unit for the image adjustment amounts as the image displacement value for the high-angle image, and in addition, it derives a displacement value in the case of displaying the oblique captured image corresponding to this high-angle image and stores it in the memory unit for the image adjustment amounts as the image displacement value for the oblique captured image.

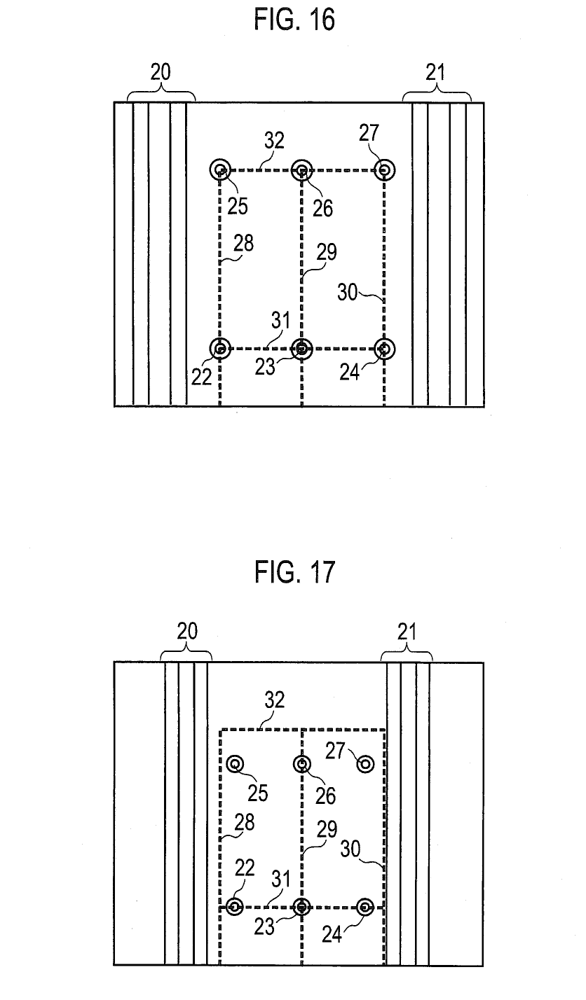

FIG. 16 shows the high-angle image moved as much as the predetermined value in the horizontal direction. From FIG. 16, it can be seen that the high-angle image and the guides for the high-angle image satisfy all of the above conditions (1) to (5).

According to the above operations, the guide is displayed appropriately.

Also, in the case where it is difficult to see the high-angle image of FIG. 16 because the image is too large, such difficulty can be resolved by the “changing operation of the parameter h of the high-angle image” function. When this operation is performed, the image control unit 7 instructs the image switching unit 6 to generate the high-angle image based on the changed value h. For example, if the parameter h is changed to a larger value, the position of the observing point of the high-angle image (the height of the virtual image pickup device 2′ of FIG. 7) moves higher, which makes the size of the high-angle image displayed on the display device 4 scaled down as a whole, thus displaying a wider range of the area on the ground.

FIG. 17 is the high-angle image when the parameter h has been changed to a larger value. To compare the high-angle image of FIG. 17 with FIG. 16, the displayed high-angle image is being zoomed out and a wider range of the area is displayed in FIG. 17 by the position of the higher observing point. In this case, an adjustment operation is needed once again, because the guides have not been changed for the high-angle image.

(4) Switching Operation from the High-Angle Image to the Oblique Captured Image

When a switching operation is performed in the instance that the high-angle image and the guides for the high-angle image of FIG. 16 are displayed, the image control unit 7 instructs the image switching unit 6 to output the oblique captured image. Also, the guide control unit 8 outputs the guides for the oblique captured image to the display control unit 10. At this time, the image control unit 7 instructs the displacement and rotation of the oblique captured image to the image control unit 10 based on the displacement and rotation amounts of the oblique captured image that are stored in the memory unit for the image adjustment amounts. Therefore, the adjustment of the guide in the case of displaying the oblique captured image and the guides for the oblique captured image already is completed.

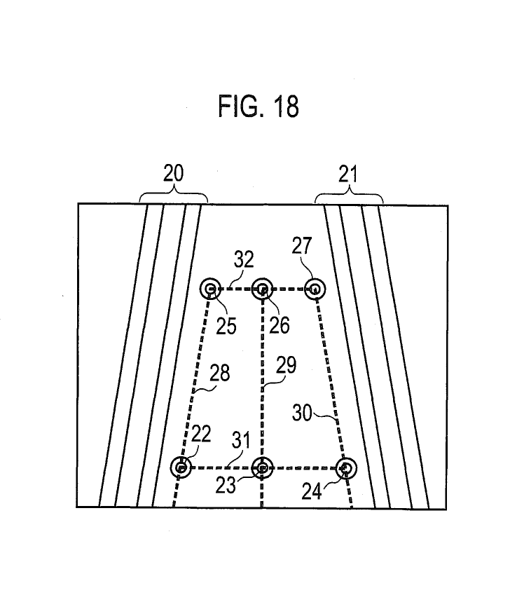

FIG. 18 is a figure in which the high-angle image and the guides for the high-angle image of FIG. 16 are switched to the oblique captured image and the guides for the oblique captured image. In FIG. 18, it can be seen that the displayed oblique captured image and guides for the oblique captured image satisfy all the above conditions (1) to (5) and the oblique captured image and the guides for the oblique captured image are appropriately displayed.

Adjustment of the guide by the vehicle operation support system 1 is completed with the operation explained above. While the explanation above was made for the operations in which the displayed high-angle image is being rotated and moved, the same operations also can be performed on the oblique captured image. In this instance also, the adjustment made to the oblique captured image is reflected in the high-angle image.

Moreover, the rotation and displacement also can be performed on the guides for the high-angle image or the guides for the oblique captured image. In this instance also, the adjustment made to the guides for the high-angle image is reflected in the guides for the oblique captured image, and the adjustment made to the guides for the oblique captured image is reflected in the guides for the high-angle image.

In the above embodiments, the captured image from the image pickup device 2 is considered as the oblique captured image. However, in some cases, an image captured by the image pickup device 2 may have distortions at its periphery. In such a case, the image needs to be processed for distortion correction. Therefore, the oblique captured image can also be an image captured by the image pickup device 2 for which the distortion correction processing has been performed.

As described above, according to the vehicle operation support system 1 of the embodiment, the user can correct or adjust misalignment after the displayed image and guides are converted to a so-called high-angle display (display as if being looked down directly below from the above) when correcting or adjusting misalignment of the oblique captured image and the guide displayed on the image pickup device 4 as desired. Therefore, the correction and adjustment can be performed by relatively simple and easy operations.

The correction and adjustment made to the image and guide in the high-angle display are reflected to the image and guide in the oblique-downwardly captured display also. Therefore, the user does not need to make correction or adjustment to the image and guide in the oblique-downwardly captured display once again, thus obviating the need of duplicate operations.

As described above, the vehicle operation support system of the embodiment can provide improved convenience and is more user-friendly compared with a conventional vehicle operation support system.

According to the present invention, it is possible to provide a vehicle operation support system that can adjust a captured image and a guide displayed on the display device easily by a simple operation. It is also possible to provide a vehicle having such a vehicle operation support system.

The invention may be embodied in other specific forms without departing from the spirit or essential characteristics thereof. The embodiments therefore are to be considered in all respects as illustrative and not restrictive; the scope of the invention being indicated by the appended claims rather than by the foregoing description, and all changes that come within the meaning and range of equivalency of the claims are therefore intended to be embraced therein.

What is claimed is:

1. A vehicle operation support system, comprising:
an image switching unit for generating a high-angle image based on an oblique captured image by an image pickup device mounted on a vehicle and outputting the high-angle image;
a guide control unit for outputting a guide for the high-angle image to support vehicle operations;
a display control unit for generating a superimposed high-angle image in which the high-angle image and the guide for the high-angle image are superimposed with each other and outputting the superimposed high-angle image to a display device;
an operation input unit; and
an image control unit,
wherein the image control unit or the guide control unit changes a first positional relation between the high-angle image and the guide for the high-angle image on the display device in accordance with a first operation input from the operation input unit.

2. The vehicle operation support system according to claim 1,
wherein the image switching unit outputs the original oblique captured image corresponding to the high-angle image,
wherein the guide control unit outputs a guide for the oblique captured image to support vehicle operations,
wherein the display control unit generates a superimposed oblique captured image in which the oblique captured image and the guide for the oblique captured image are superimposed with each other and outputting the superimposed oblique captured image, and
wherein the image control unit or the guide control unit changes a second positional relation between the oblique captured image and the guide for the oblique captured image on the display device based on a change amount of the first positional relation.

3. The vehicle operation support system according to claim 1,
wherein the image switching unit generates a high-angle image in which a mounting angle of the image pickup device is changed in accordance with a second operation input by the operation input unit.

4. The vehicle operation support system according to claim 1,
wherein the image switching unit generates a high-angle image in which a position of its observing point is changed in accordance with a third operation input by the operation input unit.

5. The vehicle operation support system according to claim 1,
wherein the image control unit or the guide control unit changes the first positional relation between the high-angle image and the guide for the high-angle image by parallel displacement, vertical displacement, or rotation of the high-angle image or of the guide for the high-angle image displayed on the display device.

6. A vehicle operation support system, comprising:
an image switching unit for outputting an oblique captured image by an image pickup device mounted on a vehicle;
a guide control unit for outputting a guide for the oblique captured image to support vehicle operations;
a display control unit for generating a superimposed oblique captured image in which the oblique captured image and the guide for the oblique captured image are superimposed with each other and outputting the superimposed oblique captured image to a display device;
an operation input unit; and
an image control unit,
wherein the image control unit or the guide control unit changes a first positional relation between the oblique captured image and the guide for the oblique captured image on the display device in accordance with a first operation input from the operation input unit.

7. The vehicle operation support system according to claim 6,
wherein the image switching unit generates a high-angle image based on the oblique captured image and outputs the high-angle image,
wherein the guide control unit outputs a guide for the high-angle image to support vehicle operations,
wherein the display control unit generates a superimposed high-angle image in which the high-angle image and the guide for the high-angle image are superimposed and outputting the superimposed high-angle image, and
wherein the image control unit or the guide control unit changes a second positional relation between the high-angle image and the guide for the high-angle image on the display device based on a change amount of the first positional relation.

8. A vehicle, comprising:
an image pickup device;
a display device;
an image switching unit for generating a high-angle image based on an oblique captured image by the image pickup device mounted on the vehicle and outputting the high-angle image;
a guide control unit for outputting a guide for the high-angle image to support vehicle operations;
a display control unit for generating a superimposed high-angle image in which the high-angle image and the guide for the high-angle image are superimposed with each other and outputting the superimposed high-angle image to the display device;
an operation input unit; and
an image control unit,
wherein the image control unit or the guide control unit changes a first positional relation between the high-angle image and the guide for the high-angle image on the display device in accordance with a first operation input from the operation input unit.

9. The vehicle according to claim 8,
wherein the image switching unit outputs the original oblique captured image corresponding to the high-angle image,
wherein the guide control unit outputs a guide for the oblique captured image to support vehicle operations,
wherein the display control unit generates a superimposed oblique captured image in which the oblique captured image and the guide for the oblique captured image are superimposed with each other and outputting the superimposed oblique captured image, and
wherein the image control unit or the guide control unit changes a second positional relation between the oblique captured image and the guide for the oblique captured image on the display device based on a change amount of the first positional relation.

10. The vehicle according to claim 8,
wherein the image switching unit generates a high-angle image in which a mounting angle of the image pickup device is changed in accordance with a second operation input by the operation input unit.

11. The vehicle according to claim 8,
wherein the image switching unit generates a high-angle image in which a position of its observing point is changed in accordance with a third operation input by the operation input unit.

12. The vehicle according to claim 8,
wherein the image control unit or the guide control unit changes the first positional relation between the high-angle image and the guide for the high-angle image by parallel displacement, vertical displacement, or rotation of the high-angle image or of the guide for the high-angle image displayed on the display device.
